(19) United States
(12) Patent Application Publication
(10) Pub. No.: US 2025/0248425 A1
(43) Pub. Date: Aug. 7, 2025

(54) CLEAR PROTEIN BEVERAGE ENHANCER

(71) Applicant: PepsiCo, Inc., Purchase, NY (US)

(72) Inventors: Seyhun GEMILI, Montville, NJ (US); Joseph Michael GLEASON, Suffield, CT (US); Thananunt ROJANASASITHARA, Yonkers, NY (US)

(21) Appl. No.: 18/429,942

(22) Filed: Feb. 1, 2024

(51) Int. Cl. A23L 2/66; A23L 2/56; A23L 2/58; A23L 2/60; A23L 33/185

(52) U.S. Cl. CPC A23L 2/66; A23L 2/56; A23L 2/58; A23L 2/60; A23L 33/185

(57) ABSTRACT

The present disclosure provides methods for removing the color in protein-containing water beverages. Colorless protein-containing water beverages are also disclosed.

### FIELD

The present disclosure provides methods for removing the color in protein-containing water beverages. The present disclosure also provides colorless protein-containing water-based beverages.

### BACKGROUND

“Protein Water,” i.e. water-based beverages comprising one or more proteins, have recently gained popularity among the beverage consuming public. The popularity of these beverages notwithstanding, formulating protein water in a manner that consumers find acceptable remains challenging, especially when using plant-based proteins. In particular, it is difficult to provide protein waters that are clear/transparent and lack color. In the case of pea proteins, for example, a yellow-green color is observed even at minimal concentrations. The presence of this color can negatively impact the appearance of the beverage to consumers. Accordingly, there is a need for water-based beverages comprising one or more proteins that have little to no color.

### SUMMARY

In certain aspects, the present disclosure provides a beverage comprising: water, a coloring agent, and one or more plant-based proteins, wherein the beverage has a ΔE value of from about 1 to about 9 in reference to pure water. In some aspects, the beverage further comprises from about 0.01 to about 0.5 wt percent of tripotassium phosphate. In some aspects, the water is carbonated. In some aspects, the water is not carbonated. In some aspects, the plant-based protein is pea protein, soy protein, rice protein, canola protein, or sunflower protein. In some aspects, the pH of the beverage is from about 2 to about 10. In some aspects, the pH of the beverage is from about 7 to about 8. In some aspects, the protein is present in a weight percentage of about 1% to about 5%.

In some aspects, the coloring agent is present in a concentration from about 0.05 ppm to about 100 ppm. In some aspects the coloring agent is derived from a natural source. In some aspects, the coloring agent is an anthocyanin, a cyclohexene dione dimer, a phycocyanin, or an agent derived from the reaction of an iridoid and an amino acid. In some aspects, the coloring agent is derived from a synthetic source. In some aspects, the coloring agent is selected from the group consisting of FD&C Red 40, Yellow 5, Yellow 6, and FD&C Blue 1.

In some aspects, the beverage further comprises at least one of a sweetener, a flavoring agent, a mineral nutritional supplement, a non-mineral nutritional supplement, or a processing aid.

In some aspects, the present disclosure provides a method of preparing the beverage of claim 1, the method comprising: dissolving the one or more plant-based proteins in water to form an aqueous plant-based protein solution; and adding the coloring agent to the aqueous plant-based protein solution in an amount sufficient to achieve a ΔE value of from about 1 to about 9 relative to water. In some aspects, the water is carbonated. In some aspects, the water is not carbonated. In some aspects, the plant-based protein is selected from pea protein, soy protein, rice protein, canola protein, and sunflower protein. In some aspects, the protein is present in a weight percentage of about 1% to about 5%.

In some aspects, the coloring agent is derived from a natural source. In some aspects, the coloring agent is selected from an anthocyanin, a cyclohexene dione dimer, a phycocyanin, or an agent derived from the reaction of an iridoid and an amino acid. In some aspects, the coloring agent is derived from a synthetic source. In some aspects, the coloring agent is selected from the group consisting of FD&C Red 40, Yellow 5, Yellow 6, and FD&C Blue 1.

### BRIEF DESCRIPTION OF THE FIGURES

FIG. 1 shows a contour plot of ΔE vs color concentration and pH for the solutions prepared in Example 3.

FIG. 2 shows a contour plot of ΔE vs color concentration and protein level for the solutions prepared in Example 3.

### DETAILED DESCRIPTION

### Definitions

The singular forms “a,” “an,” and “the” include plural referents unless the context clearly dictates otherwise.

As used herein, the term “or” is a logical disjunction (i.e., and/or) and does not indicate an exclusive disjunction unless expressly indicated as such with the terms “either,” “unless,” “alternatively,” and words of similar effect.

As used herein, the term “about” refers to ±10% of the noted value, unless otherwise specified, and unless the upper bound of the range would exceed 100% of the composition, in which case the upper limit of the range is limited to 99.99%. Thus, and by way of example only, a composition comprising about 10 weight percent of a given ingredient could have from 9 to 11 weight percent of the ingredient. Similarly, a composition comprising about 95 weight percent of a given ingredient could have from 85.5 to 99.99 weight percent of the ingredient in the composition.

As used herein, the phrase “cereal protein,” refers to a protein derived from a grain that has edible components. Examples of cereal proteins include, but are not limited to, wheat protein, rice protein, maize protein, corn protein, oat protein, barley protein, rye protein, millet protein, and sorghum protein.

As used herein, the phrase “oilseed protein,” refers to a protein derived from a seed or crop grown mainly for oil. Examples of oilseed proteins include, but are not limited to, canola protein, hemp seed protein, pumpkin seed protein, sesame seed protein, sunflower seed protein, chia seed protein, cotton seed protein, soy protein, and flax seed protein.

As used herein, the phrase “plant-based protein,” refers to a protein derived from a plant. Examples of plant-based proteins include, but are not limited to, cereal proteins, oilseed proteins, and pulse proteins.

As used herein, the phrase “processing aid” refers to a substance or substances that can be used to facilitate the manufacturing of a food product. Processing aids can be used to improve product quality and consistency, enhance nutrition, maintain product wholesomeness, enhance shelf life, and assist with packing and transportation. Exemplary processing aids include, but are not limited to, potassium carbonate, sodium bicarbonate, sodium carbonate, acetic acid, ascorbic acid, citric acid, phosphoric acid, malic acid, tripotassium phosphate, sodium hydroxide, potassium hydroxide, dipotassium phosphate, and antifoaming agents as well as agents such as antimicrobial agents.

As used herein, the phrase “pulse protein,” refers to a protein derived from the edible seed of a legume plant. Examples of pulse proteins include, but are not limited to, pea protein, bean protein, chickpea protein, and lentil protein.

All percentages provided in this specification are percentages by weight, unless specifically indicated otherwise.

### Beverages

The present disclosure provides beverages comprising water and plant-based proteins that have an appearance similar to pure water. In some aspects, the water can be carbonated. In some aspects the water can be non-carbonated. In some aspects, the beverages can comprise a coloring agent. In some aspects, the beverages can comprise a coloring agent and a buffer. In some aspects, the beverages can comprise a coloring agent and tripotassium phosphate.

In certain aspects, the one or more plant-based proteins can be selected from the group consisting of cereal proteins, oilseed proteins, and pulse proteins. In some aspects, the one or more plant-based proteins can be selected from the group consisting of wheat protein, rice protein, maize protein, corn protein, oat protein, barley protein, rye protein, millet protein, sorghum protein, canola protein, hemp seed protein, pumpkin seed protein, sesame seed protein, sunflower seed protein, chia seed protein, cotton seed protein, soy protein, flax seed protein, pea protein, bean protein, chickpea protein, lentil protein, and a mixture thereof. In some aspects, the one or more plant-based proteins can be pea protein.

In some aspects, the one or more plant-based proteins can be present in the beverage in an amount from about 0.5 wt % to about 10 wt %. In some aspects, the one or more plant-based proteins can be present in the beverage in an amount from about 0.75 wt % to about 9 wt %. In some aspects, the one or more plant-based proteins can be present in the beverage in an amount from about 1 wt % to about 8 wt %. In some aspects, the one or more plant-based proteins can be present in the beverage in an amount from about 1 wt % to about 7 wt %. In some aspects, the one or more plant-based proteins can be present in the beverage in an amount from about 1 wt % to about 6 wt %. In some aspects, the one or more plant-based proteins can be present in the beverage in an amount from about 1 wt % to about 5 wt %. In some aspects, the one or more plant-based proteins can be present in the beverage in an amount from about 1.25 wt % to about 4.5 wt %. In some aspects, the one or more plant-based proteins can be present in the beverage in an amount from about 1.5 wt % to about 4 wt %. In some aspects, the one or more plant-based proteins can be present in the beverage in an amount from about 1.75 wt % to about 3.75 wt %. In some aspects, the one or more plant-based proteins can be present in the beverage in an amount of about 0.5 wt %, about 0.6 wt %, about 0.7 wt %, about 0.8 wt %, about 0.9 wt %, about 1.0 wt %, about 1.1%, about 1.2 wt %, about 1.3 wt %, about 1.4 wt %, about 1.5 wt %, about 1.6 wt %, about 1.7 wt %, about 1.8 wt %, about 1.9 wt %, about 2.0 wt %, about 2.1 wt %, about 2.2 wt %, about 2.3 wt %, about 2.4 wt %, about 2.5 wt %, about 2.6 wt %, about 2.7 wt %, about 2.8 wt %, about 2.9 wt %, about 3.0 wt %, about 3.1 wt %, about 3.2 wt %, about 3.3 wt %, about 3.4 wt %, about 3.5 wt %, about 3.6 wt %, about 3.7 wt %, about 3.8 wt %, about 3.9 wt %, about 4.0 wt %, about 4.1 wt %, about 4.2 wt %, about 4.3 wt %, about 4.4 wt %, about 4.5 wt %, about 4.6 wt %, about 4.7 wt %, about 4.8 wt %, about 4.9 wt %, about 5.0 wt %, about 6.0 wt %, about 7.0 wt %, about 8.0 wt %, about 9.0 wt %, or about 10 wt %.

In some aspects, the one or more plant-based proteins can be pea protein. In some aspects, the pea protein has an absorbance value of 0.0020 when 0.5 g dissolved in 99.5 ml of DI water, a turbidity value of 0.0050 when 5 g dissolved in 95 ml DI water, and a turbidity value of 0.00102 when 10 g dissolved in 90 ml DI water, when measured at 600 nm wavelength. In some aspects, the pea protein can be present in the beverage in an amount from about 0.5 wt % to about 10 wt %. In some aspects, the pea protein can be present in the beverage in an amount from about 0.75 wt % to about 9 wt %. In some aspects, the pea protein can be present in the beverage in an amount from about 1 wt % to about 8 wt %. In some aspects, the pea protein can be present in the beverage in an amount from about 1 wt % to about 7 wt %. In some aspects, the pea protein can be present in the beverage in an amount from about 1 wt % to about 6 wt %. In some aspects, the pea protein can be present in the beverage in an amount from about 1 wt % to about 5 wt %. In some aspects, the pea protein can be present in the beverage in an amount from about 1.25 wt % to about 4.5 wt %. In some aspects, the pea protein can be present in the beverage in an amount from about 1.5 wt % to about 4 wt %. In some aspects, the pea protein can be present in the beverage in an amount from about 1.75 wt % to about 3.75 wt %. In some aspects, the one or more oilseed proteins can be present in the beverage in an amount of about 0.5 wt %, about 0.6 wt %, about 0.7 wt %, about 0.8 wt %, about 0.9 wt %, about 1.0 wt %, about 1.1%, about 1.2 wt %, about 1.3 wt %, about 1.4 wt %, about 1.5 wt %, about 1.6 wt %, about 1.7 wt %, about 1.8 wt %, about 1.9 wt %, about 2.0 wt %, about 2.1 wt %, about 2.2 wt %, about 2.3 wt %, about 2.4 wt %, about 2.5 wt %, about 2.6 wt %, about 2.7 wt %, about 2.8 wt %, about 2.9 wt %, about 3.0 wt %, about 3.1 wt %, about 3.2 wt %, about 3.3 wt %, about 3.4 wt %, about 3.5 wt %, about 3.6 wt %, about 3.7 wt %, about 3.8 wt %, about 3.9 wt %, about 4.0 wt %, about 4.1 wt %, about 4.2 wt %, about 4.3 wt %, about 4.4 wt %, about 4.5 wt %, about 4.6 wt %, about 4.7 wt %, about 4.8 wt %, about 4.9 wt %, about 5.0 wt %, about 6.0 wt %, about 7.0 wt %, about 8.0 wt %, about 9.0 wt %, or about 10 wt %.

In typical aspects, the beverages described herein can further comprise one or more coloring agents. In some aspects the coloring agent is derived from a natural source. In some aspects, the coloring agent is derived from anthocyanin, a betanin, carmine, a carotenoid, chlorophyll, cochineal, curcumin, a cyclohexene dione dimer, a phycocyanin, or an agent derived from the reaction of an iridoid and an amino acid.

Anthocyanins are a class of compounds that provide pigmentation and are derived from natural sources. Anthocyanins found in black currants (Ribes nigrum) that provide pigmentation include 3-diglucoside and 3-rutinoside of cyanidin and delphinidin. Similarly, blueberries (Vaccinium augustifolium or Vaccinium corymbosum) typically contain the following anthocyanins that provide pigmentation: 3-glucosides, 3-galactosides, and 3-arabinosides of cyanidin, delphinidin, peonidin, petunidin, and malvidin. Exemplary anthocyanidins have structures as described below:

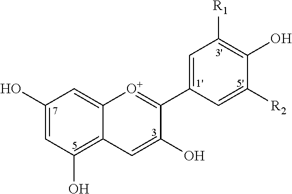

pelargonidin (R₁, R₂=H), cyanidin (R₁=OH, R₂=H), delphinidin (R₁, R₂=OH), peonidin (R₁=OCH₃, R₂=H), petunidin (R₁=OCH₃, R₂=OH), and malvidin (R₁, R₂=OCH₃).

A blue coloring agent that is derived from natural sources is gardenia blue, which may be formed by the reaction of an iridoid and an amino acid. For example, hydrolysis of the iridoid glycoside geniposide with beta-glucosidase, as indicated below, produces the iridoid genipin. Amino acids, such as glycine, lysine or phenylalanine, will react with the colorless genipin and form blue pigments:

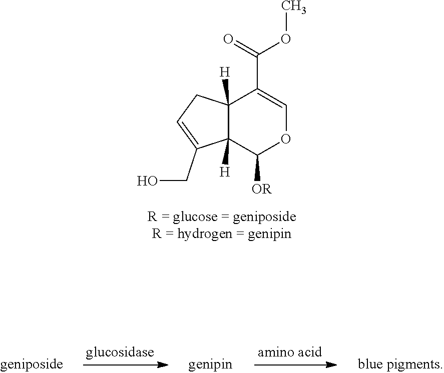

Phycocyanin is a blue protein complex found in Spirulina (blue green algae). Phycocyanins are proteins containing the covalently bound chromophore phycocyanobilin having the structure shown below:

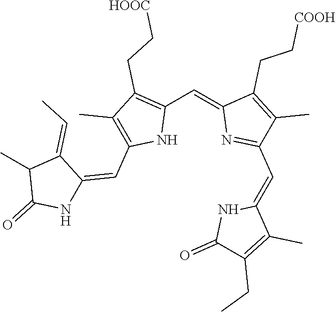

Further examples of colors derived from natural sources are Carthamus yellow and Carthamus red. Carthamus yellow and Carthamus red may be derived from safflower (Carthamus tinctorius), and include cyclohexene dione dimers, which are classified as chalcone compounds. The chemical structure of Carthamus yellow, or carthamin, is provided below:

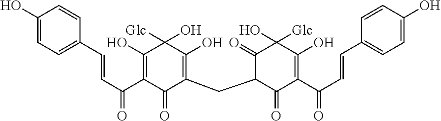

Beta-carotene and lycopene are carotenoids and are oil soluble pigments found in fruits, vegetables, etc. having the structures shown below:

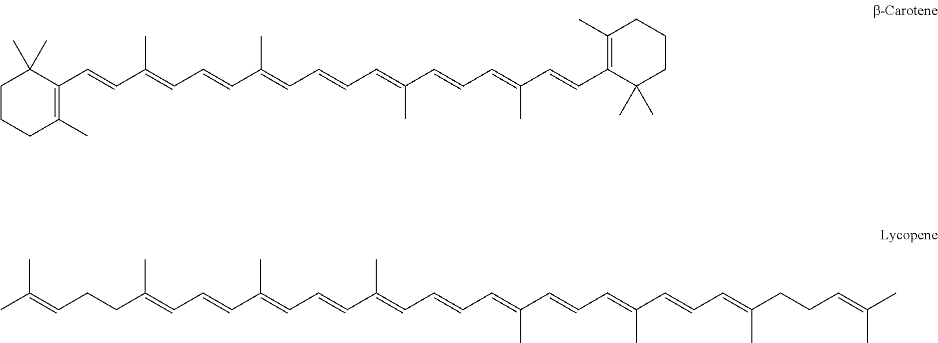

In some aspects, the coloring agent is derived from a synthetic source. In some aspects, the coloring agent is derived from azo dye (FD&C Red 40, Yellow 5, Yellow 6) and triarylmethane dye (FD&C Blue 1).

All of the aforementioned coloring agents can be purchased from well-known color manufacturing suppliers.

In some aspects, the one or more coloring agents can be present in the beverage in an amount of from about 0.05 ppm to about 100 ppm. In some aspects, the one or more coloring agents can be present in the beverage in an amount of from about 0.10 ppm to about 95 ppm. In some aspects, the one or more coloring agents can be present in the beverage in an amount of from about 0.20 ppm to about 90 ppm. In some aspects, the one or more coloring agents can be present in the beverage in an amount of from about 0.3 ppm to about 85 ppm. In some aspects, the one or more coloring agents can be present in the beverage in an amount of from about 0.40 ppm to about 80 ppm. In some aspects, the one or more coloring agents can be present in the beverage in an amount of from about 0.50 ppm to about 75 ppm. In some aspects, the one or more coloring agents can be present in the beverage in an amount of from about 0.60 ppm to about 70 ppm. In some aspects, the one or more coloring agents can be present in the beverage in an amount of from about 0.70 ppm to about 65 ppm. In some aspects, the one or more coloring agents can be present in the beverage in an amount of from about 0.8 ppm to about 60 ppm. In some aspects, the one or more coloring agents can be present in the beverage in an amount of from about 0.90 ppm to about 55 ppm. In some aspects, the one or more coloring agents can be present in the beverage in an amount of from about 1 ppm to about 50 ppm. In some aspects, the one or more coloring agents can be present in the beverage in an amount of from about 0.1.1 ppm to about 45 ppm. In some aspects, the one or more coloring agents can be present in the beverage in an amount of from about 1.10 ppm to about 40 ppm. In some aspects, the one or more coloring agents can be present in the beverage in an amount of from about 1.20 ppm to about 35 ppm. In some aspects, the one or more coloring agents can be present in the beverage in an amount of from about 1.30 ppm to about 30 ppm. In some aspects, the one or more coloring agents can be present in the beverage in an amount of from about 1.40 ppm to about 25 ppm. In some aspects, the one or more coloring agents can be present in the beverage in an amount of from about 1.50 ppm to about 20 ppm. In some aspects, the one or more coloring agents can be present in the beverage in an amount of from about 1.60 ppm ppm to about 15 ppm. In some aspects, the one or more coloring agents can be present in the beverage in an amount of from about 1.70 ppm to about 10 ppm. In some aspects, the one or more coloring agents can be present in the beverage in an amount of from about 1.80 ppm to about 9 ppm. In some aspects, the one or more coloring agents can be present in the beverage in an amount of from about 1.90 ppm to about 8 ppm. In some aspects, the one or more coloring agents can be present in the beverage in an amount of from about 2.0 ppm to about 7 ppm. In some aspects, the one or more coloring agents can be present in the beverage in an amount of from about 0.05 ppm, about 0.10 ppm, about 0.20 ppm, about 0.30 ppm, about 0.4 ppm, about 0.5 ppm, about 0.6 ppm, about 0.7 ppm, about 0.8 ppm, about 0.9 ppm, about 1.0 ppm, about 1.1 ppm, about 1.2 ppm, about 1.3 ppm, about 1.4 ppm, about 1.5 ppm, about 1.6 ppm, about 1.7 ppm, about 1.8 ppm, about 1.9 ppm, about 2.0 ppm, about 2.1 ppm, about 2.2 ppm, about 2.3 ppm, about 2.4 ppm, about 2.5 ppm, about 2.6 pm, about 2.7 ppm, about 2.8 ppm about 2.9 ppm, about 3.0 ppm, about 3.1 ppm, about 3.2 ppm, about 3.3 ppm, about 3.4 ppm, about 3.5 ppm, about 3.6 ppm, about 3.7 ppm, about 3.8 ppm, about 3.9 ppm, about 4.0 ppm, about 4.1 ppm, about 4.2 ppm, about 4.3 ppm, about 4.4 ppm, about 4.5 ppm, about 4.6 ppm, about 4.7 ppm, about 4.8 ppm, about 4.9 ppm, about 5.0 ppm, about 5.5 ppm, about 6.0 ppm, about 6.5 ppm, about 7.0 ppm, about 7.5 ppm, about 8.0 ppm, about 9.0 ppm, about 9.5 ppm, about 10.0 ppm, about 11 ppm, about 12 ppm, about 13 ppm, about 14 ppm, about 15 ppm, about 16 ppm, about 17 ppm, about 18 ppm, about 19 ppm, about 20 ppm, about 21 ppm, about 22 ppm, about 23 ppm, about 24 ppm, about 25 ppm, about 30 ppm, about 35 ppm, about 40 ppm, about 45 ppm, about 50 ppm, about 55 ppm, about 60 ppm, about 65 ppm, about 70 ppm, about 75 ppm, about 80 ppm, about 85 ppm, about 90 ppm, about 95 ppm, or about 100 pm.

In some aspects, the one or more coloring agents can be anthocyanin from radish. In some aspects, anthocyanin from radish can be present in the beverage in an amount of from about 0.05 ppm to about 100 ppm. In some aspects, anthocyanin from radish can be present in the beverage in an amount of from about 0.10 ppm to about 95 ppm. In some aspects, anthocyanin from radish can be present in the beverage in an amount of from about 0.20 ppm to about 90 ppm. In some aspects, anthocyanin from radish can be present in the beverage in an amount of from about 0.3 ppm to about 85 ppm. In some aspects, anthocyanin from radish can be present in the beverage in an amount of from about 0.40 ppm to about 80 ppm. In some aspects, anthocyanin from radish can be present in the beverage in an amount of from about 0.50 ppm to about 75 ppm. In some aspects, anthocyanin from radish can be present in the beverage in an amount of from about 0.60 ppm to about 70 ppm. In some aspects, anthocyanin from radish can be present in the beverage in an amount of from about 0.70 ppm to about 65 ppm. In some aspects, anthocyanin from radish can be present in the beverage in an amount of from about 0.8 ppm to about 60 ppm. In some aspects, anthocyanin from radish can be present in the beverage in an amount of from about 0.90 ppm to about 55 ppm. In some aspects, anthocyanin from radish can be present in the beverage in an amount of from about 1 ppm to about 50 ppm. In some aspects, anthocyanin from radish can be present in the beverage in an amount of from about 0.1.1 ppm to about 45 ppm. In some aspects, anthocyanin from radish can be present in the beverage in an amount of from about 1.10 ppm to about 40 ppm. In some aspects, anthocyanin from radish can be present in the beverage in an amount of from about 1.20 ppm to about 35 ppm. In some aspects, anthocyanin from radish can be present in the beverage in an amount of from about 1.30 ppm to about 30 ppm. In some aspects, anthocyanin from radish can be present in the beverage in an amount of from about 1.40 ppm to about 25 ppm. In some aspects, anthocyanin from radish can be present in the beverage in an amount of from about 1.50 ppm to about 20 ppm. In some aspects, anthocyanin from radish can be present in the beverage in an amount of from about 1.60 ppm ppm to about 15 ppm. In some aspects, anthocyanin from radish can be present in the beverage in an amount of from about 1.70 ppm to about 10 ppm. In some aspects, anthocyanin from radish can be present in the beverage in an amount of from about 1.80 ppm to about 9 ppm. In some aspects, anthocyanin from radish can be present in the beverage in an amount of from about 1.90 ppm to about 8 ppm. In some aspects, anthocyanin from radish can be present in the beverage in an amount of from about 2.0 ppm to about 7 ppm. In some aspects, anthocyanin from radish can be present in the beverage in an amount of from about 0.05 ppm, about 0.10 ppm, about 0.20 ppm, about 0.30 ppm, about 0.4 ppm, about 0.5 ppm, about 0.6 ppm, about 0.7 ppm, about 0.8 ppm, about 0.9 ppm, about 1.0 ppm, about 1.1 ppm, about 1.2 ppm, about 1.3 ppm, about 1.4 ppm, about 1.5 ppm, about 1.6 ppm, about 1.7 ppm, about 1.8 ppm, about 1.9 ppm, about 2.0 ppm, about 2.1 ppm, about 2.2 ppm, about 2.3 ppm, about 2.4 ppm, about 2.5 ppm, about 2.6 pm, about 2.7 ppm, about 2.8 ppm about 2.9 ppm, about 3.0 ppm, about 3.1 ppm, about 3.2 ppm, about 3.3 ppm, about 3.4 ppm, about 3.5 ppm, about 3.6 ppm, about 3.7 ppm, about 3.8 ppm, about 3.9 ppm, about 4.0 ppm, about 4.1 ppm, about 4.2 ppm, about 4.3 ppm, about 4.4 ppm, about 4.5 ppm, about 4.6 ppm, about 4.7 ppm, about 4.8 ppm, about 4.9 ppm, about 5.0 ppm, about 5.5 ppm, about 6.0 ppm, about 6.5 ppm, about 7.0 ppm, about 7.5 ppm, about 8.0 ppm, about 9.0 ppm, about 9.5 ppm, about 10.0 ppm, about 11 ppm, about 12 ppm, about 13 ppm, about 14 ppm, about 15 ppm, about 16 ppm, about 17 ppm, about 18 ppm, about 19 ppm, about 20 ppm, about 21 ppm, about 22 ppm, about 23 ppm, about 24 ppm, about 25 ppm, about 30 ppm, about 35 ppm, about 40 ppm, about 45 ppm, about 50 ppm, about 55 ppm, about 60 ppm, about 65 ppm, about 70 ppm, about 75 ppm, about 80 ppm, about 85 ppm, about 90 ppm, about 95 ppm, or about 100.

In some aspects, the beverages described herein can have one or more of the following
(a) an L* value of at least 95;
(b) an a* value of from about −1 to about 1;
(c) a b* value of from about 1 to about 7; and
(d) ΔE value of from about 1 to about 10 in reference to pure water.

The lightness value, “L*,” defines black at 0 and white at 100. L* can be measured on a colorimeter such as a Hunter Lab Colorimeter, which is an instrument that compares the amount of light passing through a solution with the amount that can pass through a sample of pure solvent. In some aspects, the beverages described herein can have an L* value of at least 90. In some aspects, the beverages described herein can have an L* value of at least 95. In some aspects, the beverages can have an L* value of from about 99 to about 100. In some aspects, the beverages can have an L* value of from about 95 to about 100. In some aspects, the beverages can have an L* value of about 90, about 91, about 92, about 93, about 94, about 95, about 96, about 97, about 98, about 99, or about 100.

The “a*” value measures the red-green component of a color, where a positive a* and a negative a* indicate red and green values, respectively. The a* value can be measured on a colorimeter such as the Hunter Lab Colorimeter described above. In some aspects, the beverages described herein can have an a* value of about −3 to about 3. In some aspects, the beverages described herein can have an a* value of about −2 to about 2. In some aspects, the beverages described herein can have an a* value of about −1 to about 1. In some aspects, the beverages can have an a* value of from about −0.9 to about 0.9. In some aspects, the beverages can have an a* value of from about −0.8 to about 0.8. In some aspects, the beverages can have an a* value of from about −0.7 to about 0.7. In some aspects, the beverages can have an a* value of from about −0.6 to about 0.6. In some aspects, the beverages can have an a* value of from about −0.5 to about 0.5. In some aspects, the beverages can have an a* value of about −3.0, about −2.9, about −2.8, about −2.7, about −2.6, about −2.5, about −2.4, about −2.3, about −2.2, about −2.1, about −2.0, about −1.9, about −1.8, about −1.7, about −1.6, about −1.5, about −1.4, about −1.3, about −1.2, about −1.1, about −1.0, about −0.9, about −0.8, about −0.7, about −0.6, about −0.5, about −0.4, about −0.3, about −0.2, about −0.2, about 0, about 0.1, about 0.2, about 0.3, about 0.4, about 0.5, about 0.6, about 0.7, about 0.8, about 0.9, about 1.0, about 1.1, about 1.2, about 1.3, about 1.4, about 1.5, about 1.6, about 1.7, about 1.8, about 1.9, about 2.0, about 2.1, about 2.2, about 2.3, about 2.4, about 2.5, about 2.6, about 2.7, about 2.8, about 2.9, or about 3.0.

The “b*” value measures the yellow-blue component of a color, where a positive b* and a negative b* indicate yellow and blue values, respectively. The b* value can be measured on a colorimeter such as the Hunter Lab Colorimeter described above. In some aspects, the beverages described herein can have a b* value of about 0 to about 10. In some aspects, the beverages described herein can have a b* value of about 1 to about 9. In some aspects, the beverages described herein can have a b* value of about 1 to about 8. In some aspects, the beverages described herein can have a b* value of about 1 to about 8. In some aspects, the beverages can have a b* value of about 0, about 0.5, about 1.0, about 1.5, about 2.0, about 2.5, about 3.0, about 3.5, about 4.0, about 4.5, about 5.0, about 5.5, about 6.0, about 6.5, about 7.0, about 7.5, about 8.0, about 8.5, about 9.0, about 9.5, or about 10.0

The ΔE value measures the difference in color between two solutions. The ΔE is calculated from the L*, a* and b* values as shown below:

$$Δ E = \sqrt{{( {L}_{2}^{*} - {L}_{1}^{*} )}^{2} + {( {a}_{2}^{*} - {a}_{1}^{*} )}^{2} + {( {b}_{2}^{*} - {b}_{1}^{*} )}^{2}}$$

The higher the ΔE, the more the color differs from water. Pure water has the following values: L₁*=100, an a₁*−0, and a b₁*−0. In some aspects, the beverages described herein can have a ΔE of from about 1 to about 15 in reference to pure water. In some aspects, the beverages described herein have a ΔE of from about 1 to about 14 in reference to pure water. In some aspects, the beverages described herein have a ΔE of from about 1 to about 13 in reference to pure water. In some aspects, the beverages described herein have a ΔE of from about 1 to about 12 in reference to pure water. In some aspects, the beverages described herein have a ΔE of from about 1 to about 11 in reference to pure water. In some aspects, the beverages described herein have a ΔE of from about 1 to about 10 in reference to pure water. In some aspects, the beverages described herein have a ΔE of from about 1 to about 9 in reference to pure water. In some aspects, the beverages described herein have a ΔE of from about 1 to about 8 in reference to pure water. In some aspects, the beverages described herein have a ΔE of from about 1 to about 7 in reference to pure water. In some aspects, the beverages described herein have a ΔE of from about 1 to about 6 in reference to pure water. 1 to about 5 in reference to pure water. In some aspects, the beverages described herein have a ΔE of about 0.5, about 1.0, about 1.5, about 2.0, about 2.5, about 3.0, about 3.5, about 4.0, about 4.5, about 5.0, about 5.5, about 6.0, about 6.5, about 7.0, about 7.5, about 8.0, about 8.5, about 9.0, about 9.5, about 10.0, about 10.5, about 11.0, about 11.5, about 12.0, about 12.5, about 13.0, about 13.5, about 14.0, about 14.5, or about 15.0 in reference to pure water.

In certain aspects, the beverage can further comprise one or more buffering agents. In some aspects the beverage can comprise one or more buffering agents selected from the group consisting tripotassium phosphate, sodium dihydrogen phosphate, phosphate buffer saline, sodium phosphate, tetrapotassium pyrophosphate, dipotassium phosphate, monopotassium phosphate, calcium pyrophosphate, calcium phosphate tribasic, calcium phosphate dibasic, calcium phosphate monobasic, magnesium phosphate tribasic, magnesium phosphate dibasic, magnesium phosphate monobasic, tetrasodium pyrophosphate, trisodium phosphate, disodium phosphate, monosodium phosphate, calcium citrate, trisodium citrate, tripotassium citrate, calcium carbonate, calcium bicarbonate, magnesium carbonate, magnesium bicarbonate, sodium carbonate, sodium bicarbonate, sodium sesquicarbonate, potassium carbonate, and potassium bicarbonate, and a mixture thereof. In some aspects, the beverage can comprise one or more buffering agents selected from the group consisting of tripotassium phosphate, dipotassium phosphate, monopotassium phosphate, calcium phosphate, magnesium phosphate, tetrasodium pyrophosphate, trisodium phosphate, disodium phosphate, monosodium phosphate, trisodium citrate, tripotassium citrate, calcium carbonate, magnesium carbonate, sodium carbonate, sodium bicarbonate, potassium carbonate, and potassium bicarbonate, and a mixture thereof. In some aspects, the beverage can comprise one or more buffering agents selected from the group consisting of tripotassium phosphate, dipotassium phosphate, monopotassium phosphate, tetrasodium pyrophosphate, trisodium phosphate, disodium phosphate, monosodium phosphate, trisodium citrate, tripotassium citrate, sodium bicarbonate, and potassium bicarbonate, and mixtures thereof. In some aspects, the one or more buffering agents can be tripotassium phosphate.

In some aspects, the one or more buffering agents can be tripotassium phosphate. In some aspects, the tripotassium phosphate can be present in the beverage in an amount from about 0.01 wt % to about 0.5 wt %. In some aspects, the tripotassium phosphate can be present in the beverage in an amount from about 0.02 wt % to about 0.45 wt %. In some aspects, the tripotassium phosphate can be present in the beverage in an amount from about 0.03 wt % to about 0.4 wt %. In some aspects, the tripotassium phosphate can be present in the beverage in an amount from about 0.04 wt % to about 0.35 wt %. In some aspects, the tripotassium phosphate can be present in the beverage in an amount from about 0.05 wt % to about 0.3 wt %. In some aspects, the tripotassium phosphate can be present in the beverage in an amount from about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.10 wt %, about 0.11 wt %, about 0.12 wt %, about 0.13 wt %, about 0.14 wt %, about 0.15 wt %, about 0.16 wt %, about 0.17 wt %, about 0.18 wt %, about 0.19 wt %, about 0.20 wt %, about 0.21 wt %, about 0.22 wt %, about 0.23 wt %, about 0.24 wt %, about 0.25 wt %, about 0.26 wt %, about 0.27 wt %, about 0.28 wt %, about 0.29 wt %, about 0.30 wt %, about 0.31 wt %, about 0.32 wt %, about 0.33 wt %, about 0.34 wt %, about 0.35 wt %, about 0.36 wt %, about 0.37 wt %, about 0.38 wt %, about 0.39 wt %, about 0.40 wt %, about 0.41 wt %, about 0.42 wt %, about 0.43 wt %, about 0.44 wt %, about 0.45 wt %, about 0.46 wt %, about 0.47 wt %, about 0.48 wt %, about 0.49 wt %, or about 0.50 wt %.

In certain aspects, the beverage described herein can comprise from about 0.5 wt % to about 10 wt % of one or more plant-based proteins, from about 0.05 ppm to about 100 ppm of one or more coloring agents; and from about 0.01 wt % to about 0.5 wt % of one or more buffering agents. In some aspects, the beverage described herein can comprise from about 0.75 wt % to about 9 wt % of one or more plant-based proteins, from about 0.10 ppm to about 95 ppm of one or more coloring agents; and from about 0.02 wt % to about 0.45 wt % of one or more buffering agents. In some aspects, the beverage described herein can comprise from about 1 wt % to about 8 wt % of one or more plant-based proteins, from about 0.20 ppm to about 90 ppm of one or more coloring agents; and from about 0.03 wt % to about 0.40 wt % of one or more buffering agents. In some aspects, the beverage described herein can comprise from about 1 wt % to about 7 wt % of one or more plant-based proteins, from about 0.30 ppm to about 85 ppm of one or more coloring agents; and from about 0.04 wt % to about 0.35 wt % of one or more buffering agents. In some aspects, the beverage described herein can comprise from about 1 wt % to about 6 wt % of one or more plant-based proteins, from about 0.40 ppm to about 80 ppm of one or more coloring agents; and from about 0.05 wt % to about 0.30 wt % of one or more buffering agents. In some aspects, the beverage described herein can comprise from about 1 wt % to about 5 wt % of one or more plant-based proteins, from about 0.50 ppm to about 75 ppm of one or more coloring agents; and from about 0.05 wt % to about 0.30 wt % of one or more buffering agents. In some aspects, the beverage described herein can comprise from about 1.25 wt % to about 4.5 wt % of one or more plant-based proteins, from about 0.60 ppm to about 70 ppm of one or more coloring agents; and from about 0.05 wt % to about 0.30 wt % of one or more buffering agents. In some aspects, the beverage described herein can comprise from about 1.5 wt % to about 4 wt % of one or more plant-based proteins, from about 0.70 ppm to about 65 ppm of one or more coloring agents; and from about 0.05 wt % to about 0.30 wt % of one or more buffering agents. In some aspects, the beverage described herein can comprise from about 1.75 wt % to about 3.75 wt % of one or more plant-based proteins, from about 1 ppm to about 50 ppm of one or more coloring agents; and from about 0.05 wt % to about 0.30 wt % of one or more buffering agents.

In some aspects, the beverage described herein can comprise from about 0.5 wt % to about 10 wt % of pea protein, from about 0.05 ppm to about 100 ppm of anthocyanin from radish; and from about 0.01 wt % to about 0.5 wt % of tripotassium phosphate. In some aspects, the beverage described herein can comprise from about 0.75 wt % to about 9 wt % of pea protein, from about 0.10 ppm to about 95 ppm of anthocyanin from radish; and from about 0.02 wt % to about 0.45 wt % of tripotassium phosphate. In some aspects, the beverage described herein can comprise from about 1 wt % to about 8 wt % of pea protein, from about 0.20 ppm to about 90 ppm of anthocyanin from radish; and from about 0.03 wt % to about 0.40 wt % of tripotassium phosphate. In some aspects, the beverage described herein can comprise from about 1 wt % to about 7 wt % of pea protein, from about 0.30 ppm to about 85 ppm of anthocyanin from radish; and from about 0.04 wt % to about 0.35 wt % of tripotassium phosphate. In some aspects, the beverage described herein can comprise from about 1 wt % to about 6 wt % of pea protein, from about 0.40 ppm to about 80 ppm of anthocyanin from radish; and from about 0.05 wt % to about 0.30 wt % of tripotassium phosphate. In some aspects, the beverage described herein can comprise from about 1 wt % to about 5 wt % of pea protein, from about 0.50 ppm to about 75 ppm of anthocyanin from radish; and from about 0.05 wt % to about 0.30 wt % of tripotassium phosphate. In some aspects, the beverage described herein can comprise from about 1.25 wt % to about 4.5 wt % of pea protein, from about 0.60 ppm to about 70 ppm of anthocyanin from radish; and from about 0.05 wt % to about 0.30 wt % of tripotassium phosphate. In some aspects, the beverage described herein can comprise from about 1.5 wt % to about 4 wt % of pea protein, from about 0.70 ppm to about 65 ppm of anthocyanin from radish; and from about 0.05 wt % to about 0.30 wt % of tripotassium phosphate. In some aspects, the beverage described herein can comprise from about 1.75 wt % to about 3.75 wt % of pea protein, from about 1 ppm to about 50 ppm of anthocyanin from radish; and from about 0.05 wt % to about 0.30 wt % of tripotassium phosphate.

In certain aspects, the beverage can further comprise one or more sweeteners. Suitable sweeteners include, but are not limited to, caloric carbohydrate sweeteners, natural high-potency sweeteners, synthetic high-potency sweeteners, and combinations thereof.

Examples of suitable caloric carbohydrate sweeteners include sucrose, fructose, glucose, erythritol, maltitol, lactitol, sorbitol, mannitol, xylitol, D-tagatose, trehalose, galactose, rhamnose, cyclodextrin (e.g., 60 -cyclodextrin, β-cyclodextrin, and λ-cyclodextrin), ribulose, threose, arabinose, xylose, lyxose, allose, altrose, mannose, idose, lactose, maltose, invert sugar, isotrehalose, neotrehalose, palatinose or isomaltulose, erythrose, deoxyribose, gulose, idose, talose, erythrulose, xylulose, psicose, turanose, cellobiose, glucosamine, mannosamine, fucose, glucuronic acid, gluconic acid, glucono-lactone, abequose, galactosamine, xylo-oligosaccharides (xylotriose, xylobiose and the like), gentio-oligoscaccharides (gentiobiose, gentiotriose, gentiotetraose and the like), galacto-oligosaccharides, sorbose, nigerooligosaccharides, fructooligosaccharides (kestose, nystose and the like), maltotetraol, maltotriol, malto-oligosaccharides (maltotriose, maltotetraose, maltopentaose, maltohexaose, maltoheptaose and the like), lactulose, melibiose, raffinose, rhamnose, ribose, isomerized liquid sugars such as high fructose corn/starch syrup (e.g., HFCS55, HFCS42, or HFCS90), coupling sugars, soybean oligosaccharides, and glucose syrup. In some aspects, the one or more sweeteners can be sucrose.

As used herein, the phrase “natural high-potency sweetener,” includes, but is not limited to, rebaudioside A, rebaudioside B, rebaudioside C (dulcoside B), rebaudioside D, rebaudioside E, rebaudioside F, rebaudioside H, rebaudioside I, rebaudioside J, rebaudioside K, rebaudioside L, rebaudioside M, rebaudioside N, rebaudioside O, rebaudioside R, rebaudioside S, rebaudioside T, rebaudioside U, rebaudioside V, dulcoside A, rubusoside, stevia, stevioside, mogroside IV, mogroside V, Luo Han Guo sweetener, siamenoside, monatin and its salts (monatin SS, RR, RS, SR), curculin, glycyrrhizic acid and its salts, thaumatin, monellin, mabinlin, brazzein, hernandulcin, phyllodulcin, glycyphyllin, phloridzin, trilobtain, baiyunoside, osladin, polypodoside A, pterocaryoside A, pterocaryoside B, mukurozioside, phlomisoside I, periandrin I, abrusoside A, cyclocarioside I, and combinations thereof.

Natural high potency sweeteners also include modified natural high potency sweeteners. Modified natural high potency sweeteners include natural high potency sweeteners that have been altered either naturally or via a chemical or biosynthetic process, and include, but are not limited to, natural high potency sweeteners that have been fermented, contacted with enzyme, derivatized, or substituted. In some aspects, at least one modified natural high potency sweeteners can be used in combination with at least one natural high potency sweeteners. In other aspects, at least one modified natural high potency sweeteners can be used without a natural high potency sweeteners. Modified natural high potency sweeteners can be substituted for a natural high potency sweeteners or can be used in combination with natural high potency sweeteners for any of the aspects described herein.

As used herein, the phrase “synthetic sweetener” refers to any composition that is not found in nature and is a high potency sweetener. Non-limiting examples of synthetic sweeteners suitable for use in the beverages described herein include, but are not limited to, sucralose, acesulfame potassium, aspartame, alitame, saccharin, neohesperidin dihydrochalcone, cyclamate, neotame, N-[3-(3-hydroxy-4-methoxyphenyl)propyl]-L-a-aspartyl]-L-phenylalanine 1-methyl ester, N-[3-(3-hydroxy-4-methoxyphenyl)-3-methylbutyl]-L-a-aspartyl]-Lphenylalanine 1-methyl ester, N-[3-(3-methoxy-4-hydroxyphenyl)propyl]-L-a-aspartyl]-L-phenylalanine 1-methyl ester, salts thereof (as appropriate), and combinations thereof.

In some aspects, the beverage can comprise one or more carbohydrate sweeteners in an amount from about 0.25 wt % to about 20 wt %. In some aspects, the beverage can comprise one or more carbohydrate sweeteners in an amount from about 0.3 wt % to about 15 wt %. In some aspects, the beverage can comprise one or more carbohydrate sweeteners in an amount from about 0.4 wt % to about 10 wt %. In some aspects, the beverage can comprise one or more carbohydrate sweeteners in an amount from about 0.4 wt % to about 9 wt %. In some aspects, the beverage can comprise one or more carbohydrate sweeteners in an amount from about 0.5 wt % to about 8 wt %. In some aspects, the beverage can comprise one or more carbohydrate sweeteners in an amount from about 0.5 wt % to about 5 wt %. In some aspects, the beverage can comprise one or more carbohydrate sweeteners in an amount of about 0.25 wt %, about 0.3 wt %, about 0.4 wt %, about 0.5 wt %, about 0.6 wt %, about 0.7 wt %, about 0.8 wt %, about 0.9 wt %, about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, about 15 wt %, about 16 wt %, about 17 wt %, about 18 wt %, about 19 wt %, or about 20 wt %.

In some aspects, the one or more carbohydrate sweeteners can be sucrose. In some aspects, the beverage can comprise sucrose in an amount from about 0.25 wt % to about 20 wt %. In some aspects, the beverage can comprise sucrose in an amount from about 0.3 wt % to about 15 wt %. In some aspects, the beverage can comprise sucrose in an amount from about 0.4 wt % to about 10 wt %. In some aspects, the beverage can comprise sucrose in an amount from about 0.4 wt % to about 9 wt %. In some aspects, the beverage can comprise sucrose in an amount from about 0.5 wt % to about 8 wt %. In some aspects, the beverage can comprise sucrose in an amount from about 0.5 wt % to about 5 wt %. In some aspects, the beverage can comprise sucrose in an amount of about 0.25 wt %, about 0.3 wt %, about 0.4 wt %, about 0.5 wt %, about 0.6 wt %, about 0.7 wt %, about 0.8 wt %, about 0.9 wt %, about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, about 15 wt %, about 16 wt %, about 17 wt %, about 18 wt %, about 19 wt %, or about 20 wt %.

In some aspects, the beverage can comprise one or more natural high potency sweeteners in a total amount ranging from about 0.1 ppm to about 700 ppm. In some aspects, the beverage can comprise one or more natural high potency sweeteners in a total amount ranging from about 0.5 ppm to about 600 ppm. In some aspects, the beverage can comprise one or more natural high potency sweeteners in a total amount ranging from about 1 ppm to about 500 ppm. In some aspects, the beverage can comprise one or more natural high potency sweeteners in a total amount ranging from about 2 ppm to about 400 ppm. In some aspects, the beverage can comprise one or more natural high potency sweeteners in a total amount ranging from about 3 ppm to about 300 ppm. In some aspects, the beverage can comprise one or more natural high potency sweeteners in a total amount ranging from about 0.1 ppm to about 280 ppm. In some aspects, the beverage can comprise one or more natural high potency sweeteners in a total amount of about 0.1 ppm, about 0.5 ppm, about 1 ppm, about 5 ppm, about 10 ppm, about 15 ppm, about 20 ppm, about 25 ppm, about 30 ppm, about 35 ppm, about 40 ppm, about 45 ppm, about 50 ppm, about 55 ppm, about 60 ppm, about 65 ppm, about 70 ppm, about 75 ppm, about 80 ppm, about 85 ppm, about 90 ppm, about 95 ppm, about 100 ppm, about 125 ppm, about 150 ppm, about 175 ppm, about 200 ppm, about 225 ppm, about 250 ppm, about 275 ppm, about 300 ppm, about 325 ppm, about 350 ppm, about 375 ppm, about 400 ppm, about 425 ppm, about 450 ppm, about 475 ppm, about 500 ppm, about 525 ppm, about 550 ppm, about 575 ppm, about 600 ppm, about 625 ppm, about 650 ppm, about 675 ppm, or about 700 ppm.

In some aspects, the one or more natural high potency sweeteners can be rebaudioside A, rebaudioside B, rebaudioside C (dulcoside B), rebaudioside D, rebaudioside E, rebaudioside F, rebaudioside H, rebaudioside I, rebaudioside J, rebaudioside K, rebaudioside L, rebaudioside M, rebaudioside N, rebaudioside O, rebaudioside R, rebaudioside S, rebaudioside T, rebaudioside U, rebaudioside V, dulcoside A, rubusoside, stevia, stevioside, mogroside IV, mogroside V, Luo Han Guo sweetener, siamenoside, monatin and its salts (monatin SS, RR, RS, SR), curculin, glycyrrhizic acid and its salts, thaumatin, monellin, mabinlin, brazzein, hernandulcin, phyllodulcin, glycyphyllin, phloridzin, trilobtain, baiyunoside, osladin, polypodoside A, pterocaryoside A, pterocaryoside B, mukurozioside, phlomisoside I, periandrin I, abrusoside A, cyclocarioside I, or a combination thereof. In some aspects, the one or more natural high potency sweeteners can be rebaudioside A, rebaudioside B, rebaudioside C, rebaudioside D, rebaudioside M, rebaudioside F, rebaudioside J, or a mixture thereof.

In some aspects, the beverage can comprise rebaudioside A, rebaudioside B, rebaudioside C, rebaudioside D, rebaudioside M, rebaudioside F, rebaudioside J, or a mixture thereof in a total amount ranging from about 0.1 ppm to about 700 ppm. In some aspects, the beverage can comprise rebaudioside A, rebaudioside B, rebaudioside C, rebaudioside D, rebaudioside M, rebaudioside F, rebaudioside J, or a mixture thereof in a total amount ranging from about 0.5 ppm to about 600 ppm. In some aspects, the beverage can comprise rebaudioside A, rebaudioside B, rebaudioside C, rebaudioside D, rebaudioside M, rebaudioside F, rebaudioside J, or a mixture thereof in a total amount ranging from about 1 ppm to about 500 ppm. In some aspects, the beverage can comprise rebaudioside A, rebaudioside B, rebaudioside C, rebaudioside D, rebaudioside M, rebaudioside F, rebaudioside J, or a mixture thereof in a total amount ranging from about 2 ppm to about 400 ppm. In some aspects, the beverage can comprise rebaudioside A, rebaudioside B, rebaudioside C, rebaudioside D, rebaudioside M, rebaudioside F, rebaudioside J, or a mixture thereof in a total amount ranging from about 3 ppm to about 300 ppm. In some aspects, the beverage can comprise rebaudioside A, rebaudioside B, rebaudioside C, rebaudioside D, rebaudioside M, rebaudioside F, rebaudioside J, or a mixture thereof in a total amount ranging from about 0.1 ppm to about 280 ppm. In some aspects, the beverage can comprise rebaudioside A, rebaudioside B, rebaudioside C, rebaudioside D, rebaudioside M, rebaudioside F, rebaudioside J, or a mixture thereof in a total amount of about 0.1 ppm, about 0.5 ppm, about 1 ppm, about 5 ppm, about 10 ppm, about 15 ppm, about 20 ppm, about 25 ppm, about 30 ppm, about 35 ppm, about 40 ppm, about 45 ppm, about 50 ppm, about 55 ppm, about 60 ppm, about 65 ppm, about 70 ppm, about 75 ppm, about 80 ppm, about 85 ppm, about 90 ppm, about 95 ppm, about 100 ppm, about 125 ppm, about 150 ppm, about 175 ppm, about 200 ppm, about 225 ppm, about 250 ppm, about 275 ppm, about 300 ppm, about 325 ppm, about 350 ppm, about 375 ppm, about 400 ppm, about 425 ppm, about 450 ppm, about 475 ppm, about 500 ppm, about 525 ppm, about 550 ppm, about 575 ppm, about 600 ppm, about 625 ppm, about 650 ppm, about 675 ppm, or about 700 ppm.

In some aspects, the beverage can further include additional ingredients, including, generally, any of those typically found in beverage compositions. Examples of such additional ingredients include, but are not limited to, flavoring agents and mineral and/or non-mineral nutritional supplements. Examples of flavoring agents include, but are not limited to, salt, caramel flavor, vanilla flavor, chocolate flavor, hazelnut flavor, honeydew flavor, strawberry flavor, raspberry flavor, and mint flavor. Examples of non-mineral nutritional supplement ingredients are known to those of ordinary skill in the art and include, for example, antioxidants and vitamins, including Vitamins A, D, E (tocopherol), C (ascorbic acid), B (thiamine), B2 (riboflavin), B6, B12, K, niacin, folic acid, biotin, and combinations thereof. The optional non-mineral nutritional supplements are typically present in amounts generally accepted under good manufacturing practices. Exemplary amounts can be between about 1% and about 100% of the United States Recommended Daily Value (RDV). In certain exemplary aspects the non-mineral nutritional supplement ingredient(s) can be present in an amount of from about 5% to about 20% RDV, where established.

The beverage described herein can also optionally include one or more processing aids. Processing aids can be used to improve product quality and consistency, enhance nutrition, maintain product wholesomeness, enhance shelf life, and assist with packing and transportation. In some aspects, processing aids can comprise substances such as potassium carbonate, potassium citrate, sodium citrate, sodium ascorbate, sodium bicarbonate, sodium carbonate, acetic acid, ascorbic acid, citric acid, phosphoric acid, malic acid, tripotassium phosphate, dipotassium phosphate, monopotassium phosphate, sodium hydroxide, potassium hydroxide, and antifoaming agents as well as agents such as antimicrobial agents (such as sodium benzoate and potassium sorbate).

In some aspects, the pH of the beverage can be from about 1 to about 10. In some aspects, the pH of the beverage can be from about 2 to about 10. In some aspects, the pH of the beverage can be from about 3 to about 9. In some aspects, the pH of the beverage can be from about 4 to about 8. In some aspects, the pH of the beverage can be from about 5 to about 8. In some aspects, the pH of the beverage can be from about 6 to about 8. In some aspects, the pH of the beverage can be from about 7 to about 8. In some aspects, the pH of the beverage can be about 0.5, about 1.0, about 1.5, about 2.0, about 2.5, about 3.0, about 3.5, about 4.0, about 4.5, about 5.0, about 5.5, about 6.0, about 6.5, about 7.0, about 7.5, about 8.0, about 8.5, about 9.0, about 9.5, or about 10.0.

### Processes

In some aspects, the beverages described herein can be prepared by dissolving the one or more plant-based proteins in water to form an aqueous plant protein solution, then adding the coloring agent to the aqueous plant protein solution in an amount sufficient to achieve the desired L*, a*, b*, and/or ΔE values. In some aspects, the water is carbonated. In some aspects, the water is not carbonated.

In some aspects, additional ingredients, including, generally, any of those typically found in beverage compositions, can be added to the beverage before or after the coloring agent is added. Examples of such additional ingredients include, but are not limited to, those previously described herein, i.e. flavoring agents, sweeteners, and mineral and/or non-mineral nutritional supplements.

The aspects described herein are further detailed with reference to the examples shown below. These examples are provided for the purpose of illustration only and the aspects described herein should in no way be construed as being limited to these examples. Rather, the aspects should be construed to encompass any and all variations which become evident as a result of the teachings provided herein.

### EXAMPLES

L* (lightness from black to white on a scale of 0 to 100), a* (negative value corresponding to green coloring and positive value corresponding to red coloring), and b* (negative value corresponding to blue coloring and positive value corresponding to yellow coloring) for each of the prepared solutions were collected using a Hunter Lab Colorimeter.

To determine the difference in color between the prepared solutions and pure water, the ΔE was calculated as shown below:

$$Δ E = \sqrt{{( {L}_{2}^{*} - {L}_{1}^{*} )}^{2} + {( {a}_{2}^{*} - {a}_{1}^{*} )}^{2} + {( {b}_{2}^{*} - {b}_{1}^{*} )}^{2}}$$

where water has an L₁*=100, an a₁*=0, and a b₁*=0. The higher the ΔE, the more the color differs from water.

To monitor turbidity, absorbance of the beverage at 600 nm was recorded.

The coloring agent used in the following examples was anthocyanin from radish, with an E1% value of 81.17% at 514 nm using pH 3.0 buffer. The E1% value is defined by the ratio of absorbance to concentration of the solution (g/100mL).

### Example 1

Protein water was prepared using the formulation shown in Table 1. This formulation was designed to have a pH of 7.5 and deliver 5 g of protein per 500 mL serving. Pea protein powder was added to a measured amount of room temperature, reverse osmosis (RO) water in a beaker and stirred at low speed until fully dissolved. Tripotassium phosphate (TKP) was added to the solution and the pH was verified using a pH meter. Anthocyanin from radish was then added to the mixture.

TABLE 1
Formulation for Example 1

| | | Reference |
|---|---|---|
| | | Formula |
| Ingredient | Weight % | Weight % |
| RO Water | 98.73% | 98.73% |
| Pea Protein Hydrolysate | 1.15% | 1.15% |
| TKP | 0.12% | 0.12% |
| Natural Red Color | 0.000015% (1.5 ppm) | 0% |
| (Vegetable Juices) | | |

Table 2 shows the color data for Example 1 compared to a reference standard containing all of the components of Table 1 except the red color.

TABLE 2
Color Data for Example 1

| | Turbidity | | | | |
|---|---|---|---|---|---|
| Sample | (abs @ 600 nm) | L* | a* | b* | ΔE |
| Reference | 0.001 | 99.01 | −2.12 | 7.49 | 7.85 |
| Example 1 | 0.008 | 95.87 | 0.09 | 4.76 | 6.30 |

While the reference sample showed a high degree of lightness, the a* value of −2.12 indicates a light green appearance while the b* value of 7.49 is indicative of a yellow appearance. Surprisingly, adding the natural red color lowered the b* and ΔE, and provided an a* that was nearly zero, indicating the solution was closer to water in color than the reference sample . . .

Turbidity levels were minimal for the reference solution and for the test solution.

### Example 2

Protein water was prepared using the formulation in Table 3. This formulation was designed to have a pH of 7.5 and deliver 5 g of protein per 500 mL serving. Pea protein powder was added to a measured amount of room temperature, reverse osmosis (RO) water in a beaker and stirred at low speed until fully dissolved. Then, TKP was added, after which the pH was verified using a pH meter. Natural red color derived from vegetable juice was added to the mixture (in Example 2, the concentration of red color was increased from to 2 ppm).

TABLE 3
Formulation for Example 2

| | | Reference |
|---|---|---|
| | | Formula |
| Ingredient | Weight % | Weight % |
| RO Water | 98.73% | 98.73% |
| Pea Protein Hydrolysate | 1.15% | 1.15% |
| TKP | 0.12% | 0.12% |
| Natural Red Color | 0.0002% (2 ppm) | 0% |
| (Vegetable Juices) | | |

Table 4 shows the color data for Example 2 compared to a reference standard containing all of the components of Table 3 except the red color.

TABLE 4
Color Data for Example 2

| | Turbidity | | | | |
|---|---|---|---|---|---|
| Sample | (abs @ 600 nm) | L* | a* | b* | ΔE |
| Reference | 0.001 | 99.01 | −2.12 | 7.49 | 7.85 |
| Example 2 | 0.008 | 95.42 | 0.6 | 4.05 | 6.14 |

As shown in the table, Example 2, which contained a 2 ppm concentration of the natural red color, had a lower ΔE than the reference solution and a lower ΔE than Example 1.

Turbidity levels were minimal in both solutions.

### Example 3

Ten solutions were prepared to examine the effect of pH range, protein content, and color concentration. Formulations are shown in Table 5.

TABLE 5
Formulations for Examples 3-1 Through 3-10

| | Pea Protein | | | | | Natural |
|---|---|---|---|---|---|---|
| | Hydrolysate | Protein | | | | Red |
| | (Weight | (g/500 mL | | RO | | Color |
| Solution | Percent) | serving) | pH | Water | TKP | (ppm) |
| 3-1 | 1.11% | 5 | 7 | 98.85% | 0.04% | 0 |
| 3-2 | 1.11% | 5 | 7 | 98.85% | 0.04% | 2.5 |
| 3-3 | 1.67% | 7.5 | 7 | 98.27% | 0.06% | 1.25 |
| 3-4 | 2.22% | 10 | 7 | 97.70% | 0.07% | 0 |
| 3-5 | 2.22% | 10 | 7 | 97.70% | 0.07% | 2.5 |
| 3-6 | 1.11% | 5 | 7.5 | 98.76% | 0.12% | 1.25 |
| 3-7 | 1.67% | 7.5 | 7.5 | 98.18% | 0.15% | 0 |
| 3-8 | 1.11% | 5 | 8 | 98.66% | 0.23% | 0 |
| 3-9 | 1.11% | 5 | 8 | 98.69% | 0.20% | 2.5 |
| 3-10 | 2.22% | 10 | 8 | 97.40% | 0.38% | 2.5 |

The solutions were prepared by adding the pea protein powder to a measured amount of room temperature, reverse osmosis (RO) water in a beaker and stirred at low speed until fully dissolved. Then, TKP was added, after which the pH was verified using a pH meter. Natural red color was then added to the solution.

Table 7 shows the color data for the ten solutions.

TABLE 5
Color Data for Solutions 3-1 Through 3-10

| | | Turbidity | | | | |
|---|---|---|---|---|---|---|
| | | (abs (@) | | | | |
| Solution | Variant | 600 nm) | L* | a* | b* | ΔΕ |
| 3-1 | 1 | 0.001 | 99.01 | −2.12 | 7.49 | 7.85 |
| 3-2 | 2 | 0.005 | 95.45 | 2.06 | 4.24 | 6.55 |
| 3-3 | 3 | 0.004 | 96.21 | −0.81 | 9.24 | 10.02 |
| 3-4 | 4 | 0.002 | 97.72 | −3.64 | 14.39 | 15.02 |
| 3-5 | 5 | 0.006 | 94.38 | 0.2 | 11.18 | 12.51 |
| 3-6 | 6 | 0.005 | 96.42 | −0.32 | 5.24 | 6.35 |
| 3-7 | 7 | 0.004 | 98.24 | −2.95 | 11.2 | 11.71 |
| 3-8 | 8 | 0.005 | 98.07 | −2.04 | 8.16 | 8.63 |
| 3-9 | 9 | 0.017 | 93.19 | 0.31 | 2.03 | 7.11 |
| 3-10 | 10 | 0.033 | 88.98 | −0.91 | 12.63 | 16.79 |

Turbidity levels were low in all of the solutions. The highest amount of turbidity was seen in Examples 3-9 and 3-10, which had higher color concentrations and higher pH levels than other solutions.

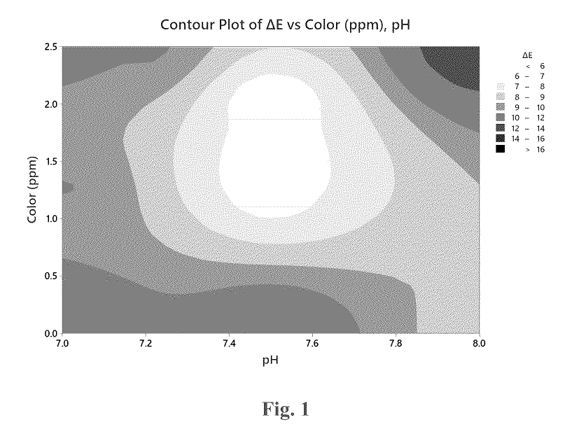

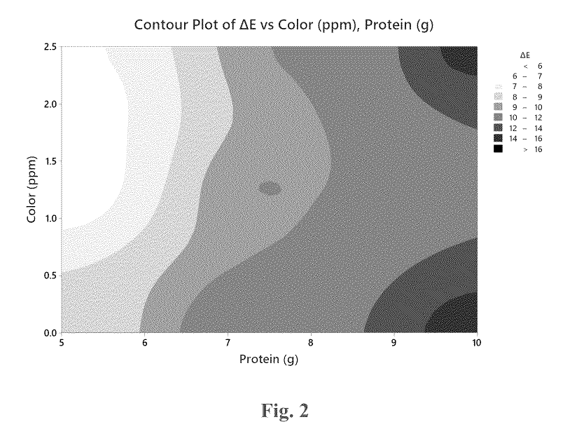

Contour plots (FIG. 1 and FIG. 2) were prepared based on the values shown in the tables.

The effect of pH and color concentration on the color of the beverage is shown in FIG. 1. Solutions with a pH range of 7.4-7.6 and a color concentration of 1-2.25 ppm (regardless of protein level) had the lowest ΔE values, meaning those solutions were closer to appearance in water.

The effect of color concentration and protein concentration on the color of the beverage is shown in FIG. 2. Solutions with lower protein concentrations had the lowest ΔE values.

The breadth and scope of the present disclosure should not be limited by any of the above-described exemplary aspects, but should be defined only in accordance with the following claims and their equivalents.

All patents, patent applications, and other reference noted or referenced in this application are hereby incorporated by reference in their entireties.

1. A beverage comprising water, a coloring agent, and one or more plant-based proteins, wherein the beverage has a ΔE value of from about 1 to about 9 in reference to pure water.

2. The beverage of claim 1, further comprising from about 0.01 to about 0.5 wt percent of tripotassium phosphate.

3. The beverage of claim 1, wherein the water is carbonated.

4. The beverage of claim 1, wherein the water is not carbonated.

5. The beverage of claim 1, wherein the plant-based protein is pea protein, soy protein, rice protein, canola protein, or sunflower protein.

6. The beverage of claim 1, wherein the pH is from about 2 to about 10.

7. The beverage of claim 6, wherein the pH is from about 7 to about 8.

8. The beverage of claim 1, wherein the protein is present in a weight percentage of about 1% to about 5%.

9. The beverage of claim 1, wherein the coloring agent is present in a concentration from about 0.05 ppm to about 100 ppm.

10. The beverage of claim 1, wherein the coloring agent is derived from a natural source.

11. The beverage of claim 10, wherein the coloring agent is an anthocyanin, a cyclohexene dione dimer, a phycocyanin, or an agent derived from the reaction of an iridoid and an amino acid.

12. The beverage of claim 1, wherein the coloring agent is derived from a synthetic source.

13. The beverage of claim 12, wherein the coloring agent is selected from the group consisting of FD&C Red 40, Yellow 5, Yellow 6, and FD&C Blue 1.

14. The beverage of claim 1, wherein the beverage further comprises at least one of a sweetener, a flavoring agent, a mineral nutritional supplement, a non-mineral nutritional supplement, or a processing aid.

15. A method of preparing the beverage of claim 1, the method comprising:
dissolving the one or more plant-based proteins in water to form an aqueous plant-based protein solution; and
adding the coloring agent to the aqueous plant-based protein solution in an amount sufficient to achieve a ΔE value of from about 1 to about 9 relative to water.

16. The method of claim 15, wherein the water is carbonated.

17. The method of claim 15, wherein the water is not carbonated.

18. The method of claim 1, wherein the plant-based protein is selected from pea protein, soy protein, rice protein, canola protein, and sunflower protein.

19. The method of claim 1, wherein the protein is present in a weight percentage of about 1% to about 5%.

20. The method of claim 15, wherein the coloring agent is derived from a natural source.

21. The method of claim 20, wherein the coloring agent is selected from an anthocyanin, a cyclohexene dione dimer, a phycocyanin, or an agent derived from the reaction of an iridoid and an amino acid.

22. The method of claim 15, wherein the coloring agent is derived from a synthetic source.

23. The method of claim 22, wherein the coloring agent is selected from the group consisting of FD&C Red 40, Yellow 5, Yellow 6, and FD&C Blue 1.
